(19) United States
(12) Patent Application Publication
(10) Pub. No.: US 2025/0367999 A1
(43) Pub. Date: Dec. 4, 2025

(54) LOCALIZED HVAC SYSTEMS FOR RECREATIONAL VEHICLES AND METHODS FOR SAME

(71) Applicant: Polaris Industries Inc., Medina, MN (US)

(72) Inventors: Jacob Frank, Milltown, WI (US); Adam H. Farmer, Wyoming, MN (US); Jacob Jain, Balsam Lake, WI (US); David A. Elia, Peoria, AZ (US)

(21) Appl. No.: 19/226,906

(22) Filed: Jun. 3, 2025

Related U.S. Application Data
(60) Provisional application No. 63/655,249, filed on Jun. 3, 2024.

(51) Int. Cl. B60H 1/00; B60K 11/04; B60N 2/015; B60N 2/56; B62D 25/14

(52) U.S. Cl. CPC B60H 1/00535; B60H 1/00285; B60H 1/00878; B60N 2/015; B60N 2/5657; B62D 25/142; B60H 2001/003; B60K 11/04

(57) ABSTRACT

A recreational vehicle having a heating, ventilation, and air conditioning (HVAC) system operably coupled to a powertrain and coupled with a frame assembly within an occupant area of the vehicle. The HVAC system includes a core configured to selectively heat or cool air, a blower configured to move the air through the core, and a plurality of ducts configured to direct the air to select portions of a cab enclosed by the frame and seating section.

### PRIORITY

This application claims the benefit of priority to U.S. Provisional Patent Application Ser. No. 63/655,249, filed Jun. 3, 2024, the content of which is incorporated herein by reference in its entirety.

### BACKGROUND

Recreational vehicles include, but are not limited to, utility terrain vehicles, side-by-side vehicles, all terrain vehicles, two- and three-wheeled motorcycles, roadsters, small boats, or recreational vessels. Many recreational vehicles include open-air occupant areas or cabs, while some recreational vehicles may include enclosed occupant areas or cabs. Provision of heating, ventilation, and air conditioning (HVAC) systems for recreational vehicles, particularly, open-cab vehicles, is challenging given space constraints within these vehicles, thermal management challenges, and HVAC system power demands.

### SUMMARY

Due to the nature of recreational vehicles and where customers ride them, volatility of weather conditions can impact customer comfort, driving the need for systems and methods configured to provide supplemental comfort to riders while still enjoying the open-air experience. The present disclosure describes systems and methods configured to provide conditioned air to strategic areas of recreational vehicle occupant areas, accessories and garments, or combinations thereof.

In some examples, the disclosure describes a recreational vehicle including a plurality of ground-engaging members; a frame assembly supported by the ground-engaging members; a seating section supported by the frame assembly and including a plurality of seats in a side-by-side configuration; a powertrain supported by the frame assembly; and a heating, ventilation, and air conditioning (HVAC) system. The HVAC system is operably coupled to the powertrain. The HVAC system includes a core configured to selectively heat or cool air, a blower configured to move the air through the core, and a plurality of ducts configured to direct the moved air to select portions of a cab defined by the frame and seating section.

In some examples, the disclosure describes an HVAC system for a recreational vehicle, which includes a body, a heater core, an evaporator, a blower, a blend door, and a recirculation circuit. The body extends from a base to a top and defines a plenum therebetween. The base defines an air inlet. The top defines an air outlet. The heater core is disposed in the plenum and operatively coupled to a coolant system of a powertrain of the recreational vehicle. The evaporator is disposed in the plenum and operatively coupled to an air-conditioning circuit of the recreational vehicle. The blower is disposed in the plenum and configured to move the air through the heater core and the evaporator. The blend door is disposed in the plenum and configured to selectively control air flow through the heater core and the evaporator. The recirculation circuit is defined by the body. The recirculation circuit includes a recirculation inlet fluidly coupled to the air outlet; a recirculation outlet fluidly coupled to the air inlet; and a recirculation blend door disposed at or between the recirculation inlet and the recirculation outlet, and wherein the recirculation blend door is configured to control a flowrate of the moved air through the recirculation circuit.

In some examples, the disclosure describes a method of controlling an air temperature within a cab of a recreational vehicle an HVAC system operably coupled to a powertrain supported by a frame assembly supported by a plurality of ground-engaging members. the method includes determining, by a controller of the HVAC system, based on a cab temperature signal received from a temperature sensor, a current cab temperature. The method also includes determining, by the controller, based on a setpoint temperature signal received from a user interface, a selected cab temperature. The method also includes determining, by the controller, a differential between the current cab temperature and the selected cab temperature. The method also includes controlling, by the controller, based on the differential, an actuation of a recirculation valve of the HVAC system.

### BRIEF DESCRIPTION OF THE DRAWINGS

The disclosure can be understood in consideration of the following detailed description of various embodiments in connection with the accompanying drawings.

FIG. 1 is a conceptual diagram illustrating an example side-by-side recreational vehicle including a central, localized modular HVAC system.

FIGS. 2A through 2D are conceptual diagrams illustrating a left front perspective view, a right back perspective view, and cross-sectional views of an example HVAC system.

FIGS. 3A through 3C are conceptual diagrams illustrating configurations of a plurality of ducts fluidly coupling an HVAC to respective ports in a vehicle.

FIG. 4 is a flow diagram illustrating an example technique of installing an HVAC system in a recreational vehicle.

FIG. 5 is a flow diagram illustrating an example technique of controlling an HVAC system of a recreational vehicle.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

The present disclosure describes systems and methods configured to provide conditioned air to strategic areas of recreational vehicle occupant areas, accessories and garments, or combinations thereof. The strategic areas are based on actual or perceived temperature of select portion of the occupant area during operation of the recreational vehicle, portions of the occupant body prioritized based on actual or perceived effect on occupant comfort, or both. For example, strategic areas for a localized HVAC system include the vehicle foot well, windshield, and seat as well as the occupant torso. Additionally, or alternatively, strategic areas may include garments or other accessories fluidly coupled to receive conditioned air from the localized HVAC system. Optionally, the conditioned air may be filtered to remove dust to enhance performance of select garments, such as dust free helmets, and to preserve the functionality of garments or accessories by mitigating buildup of dust or debris.

Vehicle Equipped with Central, Localized Modular HVAC System (30774)

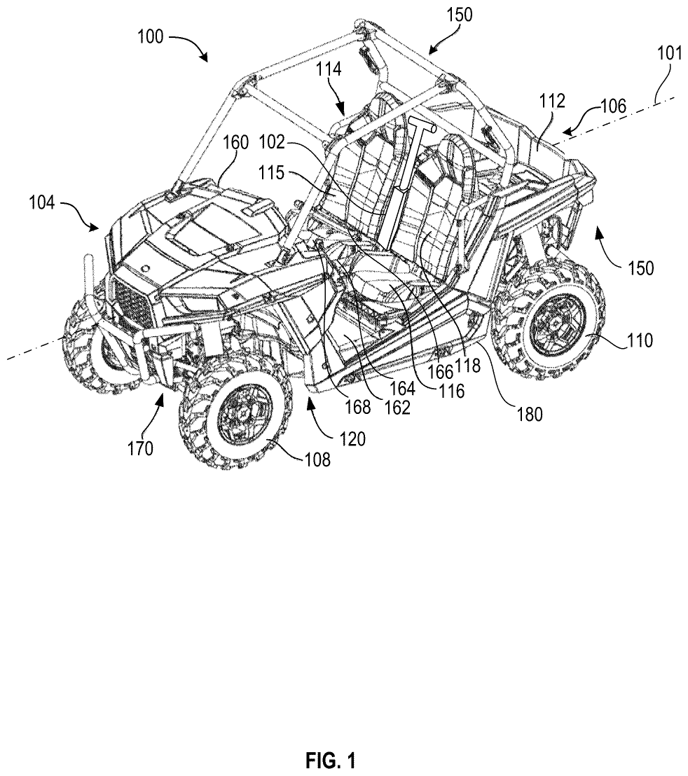

FIG. 1 is a conceptual diagram illustrating an example side-by-side recreational vehicle 100 (hereinafter, vehicle 100) including a central, localized modular HVAC system 102 (hereinafter, HVAC 102). HVAC 102 is configured to provide conditioned air to strategic areas of occupant areas in vehicle 100, garments of an occupant, accessories associated with vehicle 100, or combinations thereof.

Vehicle 100 extends along a longitudinal axis 101 from a front end 104 to a rear end 106. A plurality of ground engaging members, including front wheels 108 and rear wheels 110, support a frame assembly 120 of vehicle 100 on a ground surface. Front wheels 108 and rear wheels 110 include tires. In other examples, front wheels 108 and rear wheels 110 may include other ground engaging members such as continuous tracks.

Frame assembly 120 supports the components and systems of vehicle 100. For example, frame assembly 120 at rear end 106 supports portions of a powertrain 150. Powertrain 150 includes an internal combustion engine, a continuously variable transmission (CVT) or other transmission components, front drive train, rear drivetrain, an exhaust assembly, and an air intake assembly. In other examples, powertrain 150 includes one or more electric motors, batteries, and electrical power distribution hardware. Portions of powertrain 150, such as the engine and the transmission or the motors and batteries, may be positioned on vehicle 100 such that the weight distribution of vehicle 100 may be approximately 40/60 or approximately 35/65, as measured from front end 104 to rear end 106 along longitudinal axis 101. Additionally, the powertrain 150 is, in an example, positioned to lower the center of gravity of vehicle 100.

Frame assembly 120 also supports a cargo box 112 at rear end 106 and an occupant area 114 between front end 104 and rear end 106. Cargo box 112 includes first and second side walls and a removable base panel providing access to an engine compartment of powertrain 150 and other components of vehicle 100 positioned below cargo box 112. Occupant area 114 includes seating for at least an operator and a passenger in a side-by-side arrangement. For example, operator area 114 includes a plurality of bucket-type seats 115, each having a seat bottom 116 and a seat back 118, which may be an integral unit, coupled together, or separable. In other examples, seats 115 may include a bench-type seat, in which one seat bottom 116 and one or more seat backs 118 support both the operator and the passenger.

In some examples, the height of seat back 118 may be vertically adjustable to accommodate different heights of operators and passengers. Additionally, in one embodiment of seats 115, seat bottom 116 may be configured to slide or otherwise move in a longitudinal direction to further increase the comfort of the operator and passenger. Further details about seats 115 of vehicle 100 may be disclosed in U.S. Pat. No. 9,776,481, entitled SIDE-BYSIDE VEHICLE, the entire disclosure of which is incorporated by reference herein.

In some examples, seats 115 are configured to provide for heating, cooling, or both of seat bottom 116, seat back 118, or both. Due to the proximity of components of powertrain 150 that radiate heat during operation, such as the engine and coolant lines, to seats 115, typical automotive cooled seats which draws air into the seat from under the seat may not be suitable for use in vehicle 100. To overcome this issue, seats 115 are configured to circulate conditioned air through at least a portion of the seats 115. For example, the seats 115 include an air inlet port configured to receive therethrough conditioned air from HVAC 102 to pass the conditioned air through a ventilation circuit extending through at least an internal portion of the seat and out of an air outlet port. In some examples, an upper portion of seat back 118 includes the air inlet port and the seat bottom 116 includes the air outlet port. In some examples, the configuration of heated and cooled seats 115 is the same or substantially similar to the seats described in commonly assigned U.S. Pat. No. 11,186,338, entitled REMOTE CONTROL SYSTEM FOR COMFORT-MANAGEMENT DEVICE(S), the entire contents of which is incorporated by reference herein.

Vehicle 100 includes a dashboard assembly 160, a floorboard assembly 162, and a center console 164 (also reference to as a tunnel). Dashboard assembly 160 is coupled to frame assembly 120 and defines a forward close-off between front end 104 and occupant area 114. In some examples, dashboard assembly 160 may house one or more displays, gauges, storage compartments, audio system components, or the like. Steering wheel 166 is mounted to a steering post 168 that extends through dashboard assembly 160.

Floorboard assembly 162 extends forward of seats 115 and is optionally coupled to dashboard assembly 160. Floorboard assembly 162 includes a plurality of horizontal panels and optional dead pedals. For example, a first horizontal board supports the operator's feet, and a second horizontal board supports the passenger's feet. The horizontal boards include at least one drain having a removable cap that can be opened or removed to allow fluids, dirt, and debris to flow out of occupant area 114 when cleaning occupant area 114.

Also, vehicle 100 includes optional rock sliders 180. Rock sliders 180 are configured to protect portions of vehicle 100, such as door and door sills, from damage when crossing over obstacles such as rocks or logs. Rock sliders 180 can include any suitable material, such as one or more metals, heavy-duty box section steel, or tubular steel. In some examples, rock sliders 180 define an internal channel configured to receive therethrough routing of components of vehicle 100, such as, for example, electrical cord routings, fluid tube routings, coolant line routings, air conditioner hoses, or the like. Routing of these components of the vehicle 100 having a temperature greater than ambient temperature during operation reduces waste heat in occupant area 114 in comparison to vehicles that otherwise route such components and the associated waste heat through central sections of the vehicles such as through the center console 164 or under the floorboard assembly 162.

Frame assembly 120 also supports the HVAC system 102. In this way, the HVAC system 102 is integrated into the architecture of a recreational vehicle. The HVAC system 102 is optionally fastened to frame assembly 120 by suitable mechanical fasteners such as, for example, screws, bolts, or clamps. Alternatively, the HVAC system 102 is removably coupled to the frame assembly 120 by way of toolless mechanical fasteners such as, for example, clips, plunger anchors, or toolless clamps. Additional examples of toolless mechanical fastener include one or more of the fasteners described in commonly assigned U.S. patent application Ser. No. 17/985,977, entitled ARTICLE MOUNTING SYSTEM FOR A VEHICLE, which is incorporated by reference in its entirety.

The HVAC system 102 is, in one example, positioned within the occupant area 114. Unlike traditional automotive HVAC systems having components positioned outside of the occupant area or cabin, such as within an engine bay or within a dash assembly, the HVAC system 102 positioned within the occupant area 114 reduces the length of duct runs extending from the HVAC system 102, facilitates servicing of the HVAC system 102, enables removal of the HVAC 102 system when not in use, enables modular reconfigurability of the HVAC system 102, and facilitates after-market installation of the HVAC system 102. In other examples, the HVAC system 102 is positioned forward of the occupant area 114, such as within or forward relative to the dashboard assembly 160, or rearward of the occupant area 114, such as within the cargo box 112.

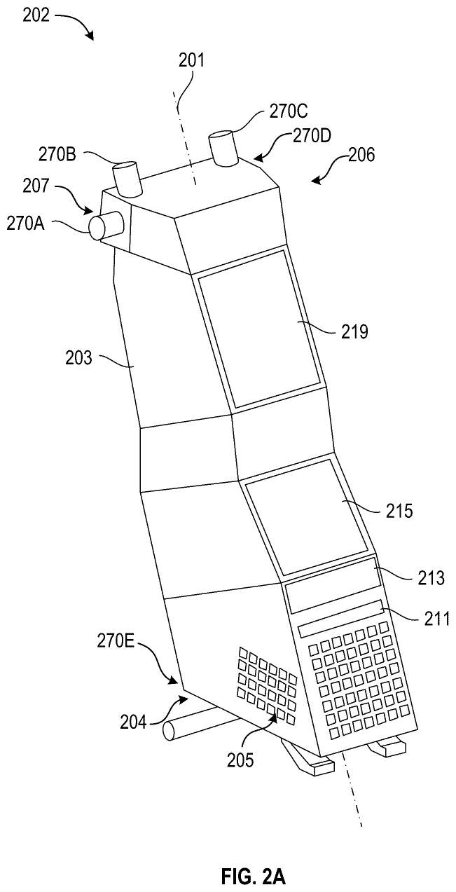

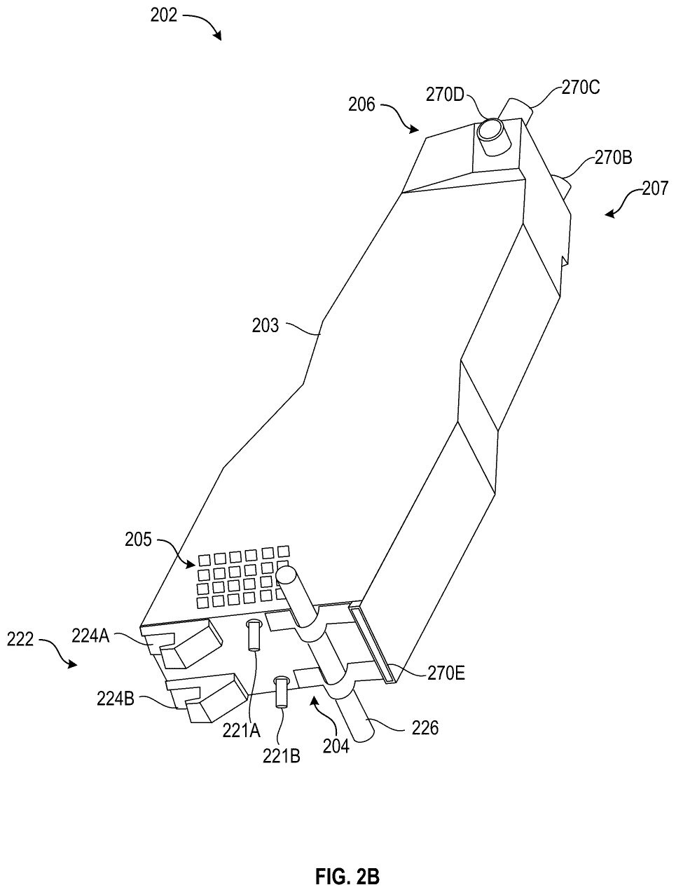

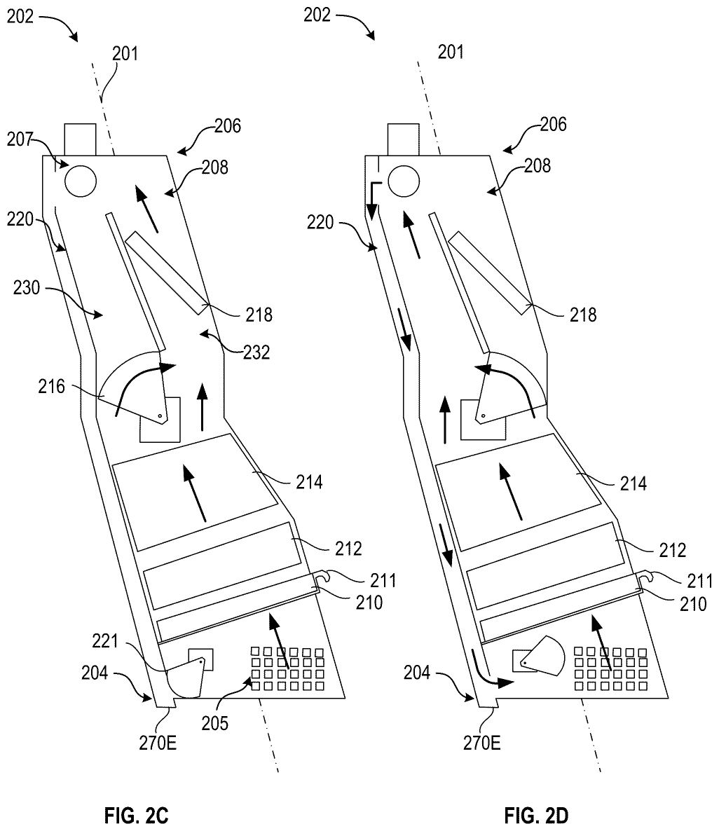

FIGS. 2A through 2D are conceptual diagrams illustrating a left front perspective view, a right back perspective view, and cross-sectional views of an example HVAC system 202. The HVAC system 202 may be the same as, or substantially similar to the HVAC system 102 described above in reference to FIG. 1, except for the differences described herein. The HVAC system 202 is configured to removably couple with a portion of a recreational vehicle (e.g., frame assembly 120) to provide conditioned air to one or more of an occupant area (e.g., occupant area 114) of an enclosed or open cab of the recreational vehicle (e.g., vehicle 100), one or more ports to which HVAC-enabled accessories may be coupled, or both. In various examples, the frame assembly 120 encloses the cab in each of an enclosed or open cab (e.g., partially encloses).

The HVAC system 202 includes a body 203 extending along a longitudinal axis 201 from a lower portion 204 (e.g., a base) to an upper portion 206 (e.g., a top of the body). Body 203 includes a plenum 208 configured to direct air therethrough. The body 203 securely retains components of the HVAC system 202 within the plenum as described herein. Components of the HVAC system 202 include, but are not limited to, one or more of a filter 210, an evaporator 212, a blower 214, a blending assembly 216, a heater core 218, or a recirculation circuit 220. The body 203 optionally includes one or more panels to access these components, such as, for example, filter door 211, evaporator panel 213, blower panel 215, and heater panel 219. In other examples, body 203 includes fewer access panels (e.g., one access panel, two access panels, or three access panels) or more access panels (e.g., five access panels or six access panels).

Additionally, the HVAC system 202 includes junctions for refrigerant lines and coolant lines, such as junctions 221A and 221B (see FIG. 2B). The body 203 is optionally insulated to reduce formation of condensation on an exterior surface of body 203 and, optionally, increase the efficiency of the HVAC system 202.

In some examples, the body 203 includes a plurality of discrete, separable rectilinear (e.g., rectangular) cylinders or other three-dimensional hollow volumes, such as tubes, columns, shafts, or the like that collectively form the body 203. Each cylinder includes a terminal edge configured to nest with and, thereby, couple to a corresponding terminal edge of at least one proximate cylinder (e.g., next to, immediately adjacent, in line, or the like). Each individual cylinder houses one or more respective components of the HVAC system 202 and each cylinder thereby comprises a discrete module of the HVAC system 202. For example, a first module including the lower portion 204 houses the filter 210 and the evaporator 212. In another example, a second module houses the blower 214. An example third module houses the blending assembly 216 and the heater 218. Another example fourth module includes the upper portion 206 and has one or more outlets of the HVAC system 202. The modular components permit swapping of modules having a non-specified (e.g., at manufacture) or non-functioning (e.g., broken) component of the HVAC system 202 with a different or replacement module without needing to remove the nonfunctioning component from the entirety of the respective body 203, such as other modules. The modular construction and assembly of the composite HVAC system 202 permit servicing of HVAC system 202 in a rural area or trail on which the vehicle is operated, for instance with the relatively smaller component modules instead of the full body 203 and components therein.

Additionally, the optional modular architecture of HVAC system 202 enables selection of components suitable to an operating environment for the vehicle. For example, a vehicle primarily operated in a northern climate includes heater core 218 but optionally excludes the evaporator 212. As another example, a vehicle primarily operated in a southern climate includes the evaporator 212 but optionally excludes the heater core 218. As another example, a vehicle primarily operated in a non-particulate environment (e.g., having decreased dust, dirt, or the like) may optionally exclude the filter 210.

In one example and referring to FIG. 2B, the HVAC system system 202 is configured to couple to a frame assembly (e.g., frame assembly 120) of a recreational vehicle (e.g., vehicle 100) by way of a toolless coupling assembly 222. The toolless coupling assembly 222 includes forward arms 224A and 224B (collectively, arms 224) and a rearward latching bar 226. The arms 224 are configured for secure receipt in corresponding sockets of the frame assembly or fixtures of the frame assembly. The latching bar 226 is received in a toolless coupling, for instance coupled with the the frame assembly 120. In some examples, the toolless mechanical couplings are similar (e.g., matching, identical, having common components, or the like) to toolless mechanical couplings configured to secure seats (e.g., seats 115) to the vehicle 100. For example, the toolless mechanical couplings are similar to the seat latching mechanisms described in commonly assigned U.S. Pat. No. 8,678,464 and U.S. patent application Ser. No. 18/8498,160, the entire contents of each of which is incorporated by reference herein.

The components of the HVAC system 202, including one or more of the filter 210, evaporator 212, blower 214, blending assembly 216, heater core 218, or the recirculation circuit 220, are configured to circulate conditioned, filtered air to one or more of an occupant space of an enclosed or open cab of the vehicle (the frame assembly 120 encloses the cab in either of an enclosed or open cab), one or more ports for coupling with HVAC system-enabled accessories, or both.

HVAC-enabled accessories include, but are not limited to, helmets, jackets, pants, boots, gloves, blankets or skirts, seats, control surfaces, storage areas, or other accessories that may be heated or cooled with conditioned air. In some examples, HVAC-enabled accessories include a booster fan configured to increase one or more of a pressure, a velocity, a flow rate, or the like of air feeding the HVAC-enabled accessory.

In some examples, the one or more ports include a quick-connect coupling having magnets or live-hinges configured to mechanically connect the port to HVAC-enabled accessories. In some examples, the one or more ports include a coupling configured to couple with an industry standard dust-free or “pumper” helmet to provide heated or cooled air that is pressurized to keep dust out of the system and, optionally, prefilter dust from the pressurized air.

The filter 210 includes a dust filter, HEPA filter, or the like. The filter 210 may include any minimum efficiency reporting value (MERV) rating, such as a MERV rating between 7 and 16. A HEPA filter includes a MERV rating equal to or greater than 17. In some examples, the HVAC system 202 includes additional filters, such as one or more prefilters, particle filters, or the like configured to remove larger particles from an air stream prior to contact with the filter 210. Prefilters or particle filters have a filter rating of between 1 to 7. In some examples, the prefilters or particle filters are configured to increase a useable life of filter 210 and may be washable.

The evaporator 212 includes a small radiator fluidly coupled (e.g., in communication) by way of refrigerant lines to other components of a refrigerant circuit. The refrigerant circuit includes, but is not limited to, one or more of a compressor, a condenser, fan, an expansion valve, or a drier. The compressor is configured to increase a pressure, and thereby a temperature, of a refrigerant in the refrigerant circuit. The compressor is operably coupled to the powertrain of the vehicle via a belt and pully and optionally operated by a clutch assembly or, alternatively, powered by an electric power source. The refrigerant may include any suitable refrigerant such as, for example, R134a, R1234yf, R744, R12a, hydrocarbon-based refrigerants, carbon dioxide-based refrigerants, or the like. The condenser is configured to decrease the temperature of the high-pressure refrigerant via heat exchange with ambient air. The condenser is optionally positioned proximate a forward end of the vehicle, proximate the vehicle roof (e.g., coupled to a portion of the roll-over protection system or ROPS), or proximate a rearward end of the vehicle (e.g., above, within, or beside the cargo area). The drier (alternatively, an accumulator) is configured to remove moisture from the cooled high-pressure refrigerant. The expansion valve (or orifice tube) decreases the pressure of the cooled high-pressure refrigerant, permits expansion of the refrigerant, and thereby decreasing the temperature of the refrigerant to below ambient temperature. The cold, lower pressure refrigerant passes through the evaporator 212 and heat is exchanged from blown air, thereby producing a conditioned stream of blown air within the plenum.

The components of the refrigerant circuit having refrigerant or otherwise operating at above ambient temperatures are, in some examples, positioned on the vehicle outside of the occupant area (e.g., outside of the cab). In this way, infiltration into the occupant area of waste heat produced by these components of the refrigerant circuit are reduced (e.g., decreased or prevented).

The blower 214 in the body 203 is configured to move air through the plenum 208 of HVAC system 202, thereby drawing in air from the occupant area, and optionally recirculation circuit 220, and blowing conditioned air out of the HVAC system 202 and into specified portions of the occupant area. Although described as a blower, in other examples, the blower includes, but is not limited to, a fan or other air moving device. In some examples, the blower 214 includes two or more blowers or fans. In some examples, the HVAC system 202 includes a plurality of blowers, fans, or the like in series or parallel that are configured to push or draw air through select portions of the occupant space, HVAC-enabled accessories, or both. For example, the HVAC system 202 may include blower 214 and one or more auxiliary or supplemental fans or blowers in select portions of ducts fluidly coupled to the HVAC system 202.

The blending assembly 216 controls flow paths of air within the plenum 208. For example, the plenum 208 includes a cooling channel 230 and a heating channel 232. When operating in a cooling mode, the blending assembly 216 (e.g., a louver, damper, or the like) closes off the heating channel 232 and air flows preferentially through the cooling channel 230 (see FIG. 2D). When operating in a heating mode, the blending assembly 216 closes off the cooling channel 230 and air preferentially flows through the heating channel 232 (see FIG. 2C). In this way, the blending assembly 216 permits rapid conversion of the HVAC system 202 between cooling and heating modes. In another example, in a blend mode, the blending assembly 216 partially closes either or both of the cooling channel 230 or heating channel 232 to control a temperature of air output from HVAC system 202. The blending assembly 216, such as a damper, shown in FIGS. 2C, 2D is optionally positioned between each of the cooling channel 230 and the heating channel 232.

The heater core 218 is configured to heat air. The heater core 218 in an example includes a radiator that is fluidly coupled to the engine coolant lines. The heater core 218 coupled with the engine coolant lines utilizes waste heat from the engine to heat the occupant area (e.g., the cab), accessories, or the like. Optionally, coolant flow to the heater core 218 is controlled by one or more valves. Alternatively, the heater core 218 includes a resistance heater, for instance powered by an electric power source such as a vehicle battery.

The recirculation circuit 220 is configured to recirculate conditioned air from the HVAC outlet 207 to the HVAC inlet 205 for further conditioning. The recirculation circuit 220 includes an optional blend door 221. The blend door 221 (e.g., a louver, damper, or the like) controls a flowrate of air through the recirculation circuit 220. For example, when operating in a first mode (e.g., a heating mode) as illustrated in FIG. 2C, the blend door 221 is in a closed configuration or in a minimum flow rate position. When operating in a second mode (e.g., a cooling mode) as illustrated in FIG. 2D, the blend door 221 is optionally in an open configuration or a maximum flow rate position that permits recirculating of air for additional cooling. Optionally, the blend door 221 is opened or closed in either of heating or cooling configurations depending on specifications (e.g., of the operator, control system, or the like).

In some examples, the recirculation circuit 220 permits the HVAC system 202 to rapidly reach a selected outlet air temperature in comparison to a system without a recirculation circuit. For example, when operating in a cooling mode, the blend door 221 is in an open configuration to permit flow through the recirculation circuit 220. The recirculated air is administered to the evaporator 212 again to further cool the air and thereby rapidly cool output air.

Additionally, or alternatively, the recirculation circuit 220 controls an output flow rate of air. For example, given the same speed of blower 214, when blend door 221 is in a closed configuration a flow rate of output air is greater than when the blend door 221 is in an open configuration. In the open configuration a flow rate of output air is less than the maximum as some of the otherwise output air is recirculated. The recirculation circuit provides an operator with a perception of a reduced fan speed rate, volumetric flow rate, or the like. At the same time, the heater 218 or evaporator 212 are able to operate at increased efficiency given that the recirculated air temperature is closer to a selected set point temperature than ambient air received through the inlet 205.

One or more ports 270A, 270B, 207C, 270D, and 270E (collectively, ports 270) are provided (see FIG. 2A). The one or more ports 207 are coupled with one or more of HVAC-enabled accessories, ducts, or the like. The ports 207 provide conditioned air to one or more of an occupant area (e.g., occupant area 114) of an enclosed or open cab of the recreational vehicle (e.g., vehicle 100), HVAC enabled accessories, or the like. Each duct of the plurality of ducts is configured to direct the air (e.g., conditioned air) to select portions of a cab enclosed by the frame and seating section (whether an open or closed cab). For example, the ports 270A and 270D are configured to fluidly couple with ducts directing air toward a torso of an occupant, a ventilated seat, or both. Ports 270B and 270C, in another example, are configured to fluidly couple to respective ducts directing moved air toward a head of an occupant, a ventilated helmet, or both. In a further example, port 270E is configured to fluidly couple to an associated duct directing air toward one or more of a dash assembly, a footwell, a windshield, or combinations thereof.

### Functional HVAC System/Localized Recirculation (30990)

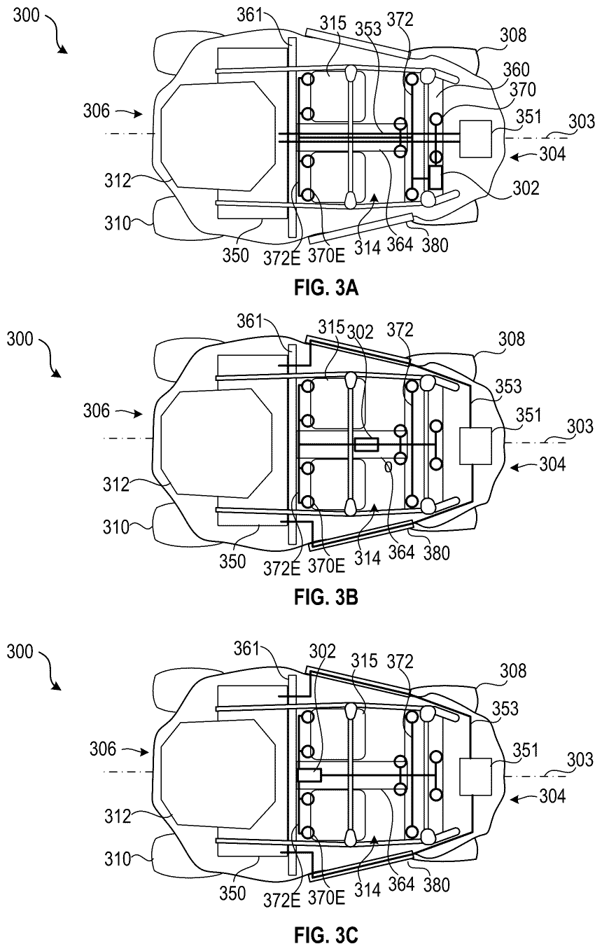

FIGS. 3A through 3C are conceptual diagrams illustrating configurations of a plurality of ducts 372 fluidly coupling an HVAC system 302 to respective ports 370 in a vehicle 300. Vehicle 300 may be the same or substantially similar to vehicle 100 described above in reference to FIG. 1. For example, vehicle 300 extends from a front end 304 to a rear end 306 and includes front wheels 308 and rear wheels 310 supporting a frame assembly 320. Frame assembly 320 supports powertrain 350 having a coolant system 351 with coolant line 353, cargo box 312, occupant area 314 having seats 315, dash assembly 360, and rock sliders 380. Powertrain 350 is separated from occupant area 314 by rear close-off 361. Coolant system 351 includes a radiator that may be positioned forward of dash assembly 360, rearward of rear close-off, or supported by portions of frame assembly 320 therebetween.

As illustrated in FIG. 3A, HVAC system 302 is positioned in dash assembly 360. While dash assembly 360 may be suitable for containing and protecting HVAC system 302, positioning of HVAC system 302 within dash assembly 360 may make servicing of HVAC system 302 more difficult than if HVAC system 302 were positioned outside of dash assembly 360. Moreover, ducts 372 coupled to rearward ports 370 (e.g., duct 372E coupled to port 370E) have a length making ducts 372 susceptible to heating during operation of vehicle 300. For example, coolant lines 353 routed through center console 364 produce waste heat during operation of vehicle 300 that heats ducts 372 extending through center console 364 as well as heating of occupant area 314.

To reduce heat transfer from components of vehicle 300 to ducts 372, coolant lines 353 may be insulated (e.g., with a fiber glass or close cell foam insulation), routed through other portions of vehicle (e.g., through rock sliders 380), or both. Additionally, or alternatively, HVAC system 302 may be positioned in other portions of vehicle 300, such as, for example, within occupant area 314 or within center console 364.

As illustrated in FIG. 3B, HVAC system 302 is positioned within center console 364. The longest runs of ducts 372 (e.g., duct 372E coupled to port 370E) is about 50% shorter compared to the longest runs of ducts 372 illustrated in FIG. 3A. In some examples, the longest run of ducts is within a range from about 3 feet to about 6 feet. Additionally, coolant lines extending from powertrain 350 (e.g., the engine) to coolant system 351 (e.g., radiator) are routed through rock sliders 380. As such, the configuration illustrated in FIG. 3B reduces heat transfer to ducts 372. This reduction in heat transfer results is conditioned air output at ports 370 that is closer to a temperature of the air when output from HVAC system 302.

To further enhance the actual or perceived effect of HVAC system 302, HVAC system 302 may be positioned closer to ports 370 that direct air toward select portions of a body of an occupant. For example, HVAC system 302 may be positioned closer to the head or torso of the occupant.

As illustrated in FIG. 3C, HVAC system 302 is positioned at or adjacent to a midline 303 of vehicle 300, e.g., within or on center console 364, and between dash assembly 360 and a rear close-off 361, such as between seats 315 (e.g., in an upright configuration between seatbacks). This example upright configuration of the HVAC system 302 further reduces heat transfer to the ducts 372 configured to direct conditioned air toward a head and a torso of the occupants. Additionally, a pressure and/or air velocity at ports 370 configured to direct conditioned air toward a head and a torso of the occupants relative to a pressure and/or air velocity at the outlet of HVAC system 302 is reduced. In this was, the configuration of HVAC system 302 illustrated in FIG. 3C may further enhance the actual or perceived effect of HVAC system 302 in directing conditioned air toward the occupants.

Tests were performed to measure the outlet port air temperatures during cooling of conditioned air during vehicle operation for configurations of an HVAC system positioned within a dash assembly and on or adjacent a midline of a vehicle within the occupant area. Test results demonstrated that air temperature at outlet ports was cooler for HVAC system configuration having the HVAC system positioned on or adjacent a midline of a vehicle within the occupant area.

Although illustrated as a two-seat vehicle, in other example, vehicle 300 may include additional seats, such as three seats, four seats, five seats, or six seats arranged in two or three rows of two or more seats. In vehicles having more than two seats, HVAC system 302 may be positioned one or along midline 303 in or on center console 364 between or behind any selected row of seats.

In some examples, HVAC system 302 defines functional features of the center console 364. For example, a body of HVAC system 302 may define interior body styling, cup holders, enclosed and/or sealed storage such as a glove box, electronic accessory ports ranging from a USB connection port to a weather pack connector to a standard 12V accessory port, a hinged armrest, molle attachment panels, prop-shaft guarding, electrical and hose routings, cabin close off functionality, attachment ports for ventilation enables seats or helmets, or the like.

In some examples, HVAC system 302 may include separate control interfaces at select locations within occupant area 314. For example, each of ports 370 may include a louvered outlet cap. In this way, occupants may control the conditioned air supplied to the select portions of the occupant space or ports servicing the select portion of the occupant space. The separate control interfaces may include passive or direct control to adjust airflow and temperature separate from the rest of the HVAC system.

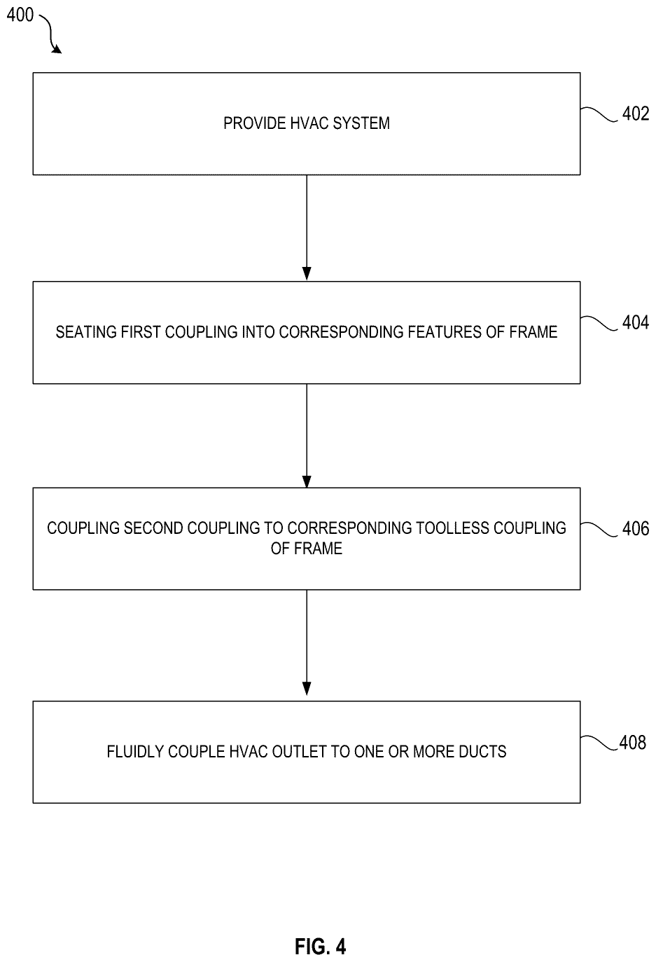

The HVAC systems described herein may be installed and controlled by any suitable techniques. FIG. 4 is a flow diagram illustrating an example technique 400 of installing an HVAC system in a recreational vehicle. Although technique 400 is described in reference to HVAC system 202 illustrated in FIGS. 2A through 2D, the technique may be used to install other HVAC systems. Additionally, HVAC system 202 may be installed using other techniques.

Technique 400 includes providing HVAC system 202 (402). Technique 400 also includes seating a first mechanical coupling, such as arms 224, into corresponding features extending from a frame assembly of the recreational vehicle (404). Technique 400 also includes removably coupling a second mechanical coupling, such as rearward latching bar 226, to one or more corresponding toolless couplings extending from the frame assembly (406). Technique 400 also includes fluidly coupling HVAC system outlet 207 to one or more ducts configured to direct conditioned air from HVAC system 202 toward select portions of vehicle 200 (408).

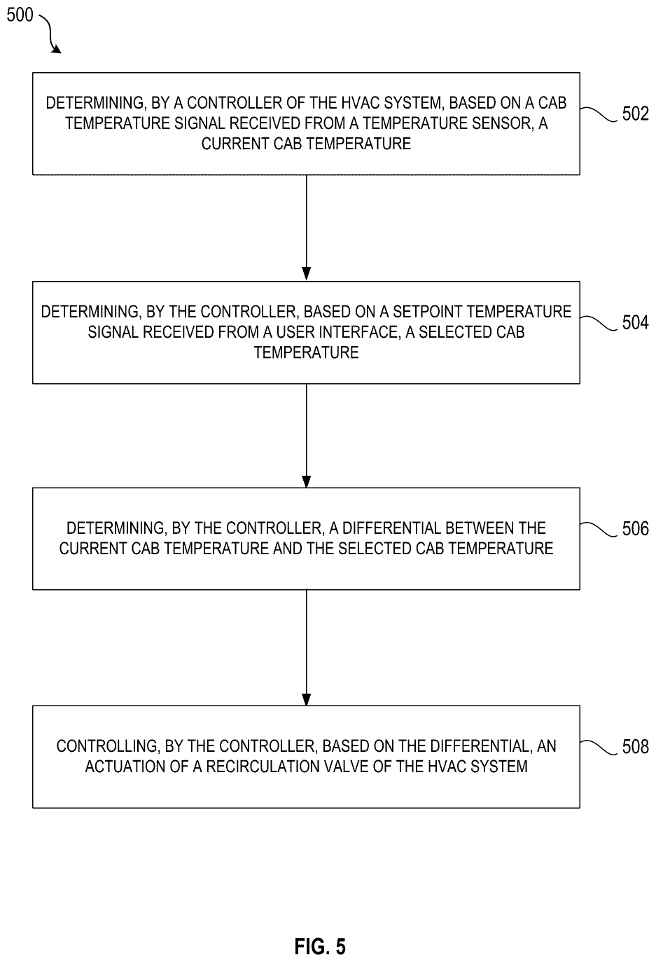

FIG. 5 is a flow diagram illustrating an example technique 500 of controlling an HVAC system system of a recreational vehicle. Although technique 500 is described in reference to HVAC system 202 illustrated in FIGS. 2A through 2D, the technique may be used to control other HVAC systems. Additionally, HVAC system 202 may be controlled using other techniques.

Technique 500 includes determining, by a controller of the HVAC system, based on a cab temperature signal received from a temperature sensor, a current cab temperature (502). Technique 500 also includes determining, by the controller, based on a setpoint temperature signal received from a user interface, a selected cab temperature (504). Technique 500 also includes determining, by the controller, a differential between the current cab temperature and the selected cab temperature (506). Technique 500 also includes controlling, by the controller, based on the differential, an actuation of a recirculation valve of the HVAC system (508).

In some examples, the HVAC system is supported by and removably coupled to the frame assembly, and technique 500 includes removably coupling the HVAC system to the frame assembly. For example, technique 500 may include positioning the HVAC system along a lateral midline of the recreational vehicle between a dash and a rear close-off of the vehicle. Additionally, or alternatively, technique 500 may include positioning the HVAC system between at least two seats of a plurality of seats arranged in a side-by-side configuration.

In some examples, the HVAC system includes a heater core configured to selectively heat air, an evaporator core configured to selectively cool the air, a blower configured to move the air through the core, and technique 500 includes controlling, by the controller, based on the differential, a power state of at least one of the heater core, the evaporator core, and the blower.

In some examples, the HVAC system includes a plurality of ducts configured to direct the moved air to select portions of a cab defined by the frame and seating section, and wherein the method further comprises coupling a respective duct of the plurality of ducts to at least one of a ventilated seat and a helmet ventilation coupling port.

In some examples, the HVAC system includes a plurality of ducts configured to direct the moved air to select portions of a cab defined by the frame and seating section, and technique 500 includes coupling a respective duct of the plurality of ducts to at least one auxiliary coupling port configured to fluidly couple to an accessory, wherein the accessory comprises at least one of a blanket, a jacket, a pant, a boot, a glove, a storage box, a cooler, a boot/glove/garment forced air dryer rack, and a tent.

The following clauses illustrate example subject matter described herein.
Clause 1. A recreational vehicle, comprising: a plurality of ground-engaging members; a frame assembly supported by the ground-engaging members; a seating section supported by the frame assembly and including a plurality of seats in a side-by-side configuration; a powertrain supported by the frame assembly; and a heating, ventilation, and air conditioning (HVAC) system operably coupled to the powertrain, wherein the HVAC system comprises a core configured to selectively heat or cool air, a blower configured to move the air through the core, and a plurality of ducts configured to direct the moved air to select portions of a cab defined by the frame and seating section.
Clause 2. The recreational vehicle of clause 1, wherein the HVAC system is supported by the frame assembly at or adjacent to a midline of the recreational vehicle within the cab between a dash assembly and a rear close-off.
Clause 3. The recreational vehicle of clause 1 or 2, wherein the HVAC system is supported by the frame assembly between a first seat and a second seat of the plurality of seats.
Clause 4. The recreational vehicle of any one of clauses 1 through 3, wherein the HVAC system is removably coupled to the frame assembly.
Clause 5. The recreational vehicle of any one of clauses 1 through 4, wherein the HVAC system further comprises an air filter fluidly coupled to an intake of the core.
Clause 6. The recreational vehicle of any one of clauses 1 through 5, wherein the HVAC system further comprises a recirculation circuit comprising a recirculation inlet fluidly coupled to an outlet of the core, a recirculation outlet fluidly coupled to an inlet of the core, and a recirculation valve disposed between the recirculation inlet and the recirculation outlet, wherein the recirculation valve is configured to control a flowrate of the moved air through the recirculation circuit.
Clause 7. The recreational vehicle of any one of clauses 1 through 6, wherein the recreational vehicle further comprises a controller operatively coupled to the HVAC system, wherein the controller is configured to control at least one of an operational state of the core, a speed of the blower, and a state of the recirculation valve.
Clause 8. The recreational vehicle of any one of clauses 1 through 7, wherein the core comprises a evaporator defining a first airflow path and a heating core defining a second airflow path, wherein the first airflow path is arranged in parallel with the second airflow path, and wherein the HVAC system further comprises blend doors and junctions for the refrigerant and coolant lines.
Clause 9. The recreational vehicle of any one of clauses 1 through 8, wherein the select portions of the cab comprise at least one of a ventilated seat and a helmet ventilation coupling port.
Clause 10. The recreational vehicle of any one of clauses 1 through 9, wherein the select portions of the cab comprise at least one of a footwell, a windshield, and a dash.
Clause 11. The recreational vehicle of any one of clauses 1 through 10, wherein the select portions of the cab comprises at least one auxiliary coupling port configured to fluidly couple to an accessory, wherein the accessory comprises at least one of a blanket, a jacket, a pant, a boot, a glove, a storage box, a cooler, a boot/glove/garment forced air dryer rack, and a tent.
Clause 12. The recreational vehicle of any one of clauses 1 through 11, wherein a length of each respective duct of the plurality of ducts is less than approximately 6 feet (1.83 meters).
Clause 13. The recreational vehicle of any one of clauses 1 through 12, wherein the select portions of the cab comprise at least one of a ventilated seat and a helmet ventilation coupling port, and wherein a length of a respective duct of the plurality of ducts fluidly coupled to the at least one of the ventilated seat and the helmet ventilation coupling port is less than about 3 feet (0.91 meters).
Clause 14. The recreational vehicle of any one of clauses 1 through 13, wherein the HVAC system is intermediate the seats, wherein the select portions of the cab comprise at least one of a footwell, and wherein at least one duct of the plurality of ducts extends from the core toward a dash of the recreational vehicle, and wherein the at least one duct comprises a low profile duct.
Clause 15. The recreational vehicle of any one of clauses 1 through 14, wherein the HVAC system further comprises an auxiliary fan fluidly coupled to the core and the blower by at least one duct of the plurality of ducts.
Clause 16. The recreational vehicle of any one of clauses 1 through 15, wherein the recreational vehicle further comprises body panels, doors, and windows supported by respective portions of the frame and defining an enclosed cab.
Clause 17. The recreational vehicle of any one of clauses 1 through 16, wherein the recreational vehicle further comprises a radiator operatively coupled to at least a portion of the powertrain by at least one coolant line, wherein the coolant line is routed outside of or adjacent to a laterally outer extent of the cab, and wherein the at least one coolant line is exposed to the atmosphere.
Clause 18. The recreational vehicle of any one of clauses 1 through 17, wherein the recreational vehicle further comprises: a rock slider coupled to and extending laterally outward from at least a portion of the frame assembly; and a radiator operatively coupled to at least a portion of the powertrain by at least one coolant line, wherein the at least a portion of the cooling line is routed through at least a portion the rock slider.
Clause 19. A method of controlling an air temperature within a cab of a recreational vehicle a heating, ventilation, and air conditioning (HVAC) system operably coupled to a powertrain supported by a frame assembly supported by a plurality of ground-engaging members, wherein the method comprises: determining, by a controller of the HVAC system, based on a cab temperature signal received from a temperature sensor, a current cab temperature; determining, by the controller, based on a setpoint temperature signal received from a user interface, a selected cab temperature; determining, by the controller, a differential between the current cab temperature and the selected cab temperature; and controlling, by the controller, based on the differential, an actuation of a recirculation valve of the HVAC system.
Clause 20. The method of claim 19, wherein the HVAC system is supported by and removably coupled to the frame assembly, and wherein the method further comprises removably coupling the HVAC system to the frame assembly.
Clause 21. The method of claim 19 or 20, wherein the method further comprises positioning the HVAC system along a lateral midline of the recreational vehicle between a dash and a rear close-off of the vehicle.
Clause 22. The method of clause 21, wherein positioning the HVAC system further comprises positioning the HVAC system between at least two seats of a plurality of seats arranged in a side-by-side configuration.
Clause 23. The method of any one of clauses 19 through 22, wherein the HVAC system further comprises a heater core configured to selectively heat air, an evaporator core configured to selectively cool the air, a blower configured to move the air through the core, and wherein the method further comprises controlling, by the controller, based on the differential, a power state of at least one of the heater core, the evaporator core, and the blower.
Clause 24. The method of any one of clauses 19 through 23, wherein the HVAC system further comprises a plurality of ducts configured to direct the moved air to select portions of a cab defined by the frame and seating section, and wherein the method further comprises coupling a respective duct of the plurality of ducts to at least one of a ventilated seat and a helmet ventilation coupling port.
Clause 25. The method of any one of clauses 19 through 24, wherein the HVAC system further comprises a plurality of ducts configured to direct the moved air to select portions of a cab defined by the frame and seating section, and wherein the method further comprises coupling a respective duct of the plurality of ducts to at least one auxiliary coupling port configured to fluidly couple to an accessory, wherein the accessory comprises at least one of a blanket, a jacket, a pant, a boot, a glove, a storage box, a cooler, a boot/glove/garment forced air dryer rack, and a tent.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

1. A recreational vehicle, comprising:
a plurality of ground-engaging members;
a frame assembly supported by the ground-engaging members;
a seating section supported by the frame assembly and including a plurality of seats in a side-by-side configuration;
a powertrain supported by the frame assembly; and
a heating, ventilation, and air conditioning (HVAC) system operably coupled to the powertrain, wherein the HVAC system includes:
a core configured to selectively heat or cool air;
a blower configured to move the air through the core; and
a plurality of ducts in communication with the core configured to direct the air to select portions of a cab enclosed by the frame and the seating section.

2. The recreational vehicle of claim 1, wherein the HVAC system is supported by the frame assembly proximate a midline of the recreational vehicle within the cab between a dash assembly and a rear close-off.

3. The recreational vehicle of claim 1, wherein the HVAC system is supported by the frame assembly between a first seat and a second seat of the plurality of seats.

4. The recreational vehicle of claim 1, wherein the HVAC system is removably coupled to the frame assembly.

5. The recreational vehicle of claim 1, wherein the HVAC system further comprises a recirculation circuit comprising a recirculation inlet fluidly coupled to an outlet of the core, a recirculation outlet fluidly coupled to an inlet of the core, and a recirculation blend door disposed at or between the recirculation inlet or the recirculation outlet, and wherein the recirculation blend door is configured to control a flowrate of the moved air through the recirculation circuit.

6. The recreational vehicle of claim 1, wherein the core comprises a evaporator core defining a first airflow path and a heating core defining a second airflow path, wherein the first airflow path is arranged in parallel with the second airflow path, and wherein the HVAC system further comprises at least one blend door configured to control a flowrate of the moved air in the first airflow path and the second airflow path.

7. The recreational vehicle of claim 1, wherein the select portions of the cab comprise at least one of a ventilated seat, a helmet ventilation coupling port, a footwell, a windshield, a dash, or an auxiliary coupling port configured to fluidly couple to an accessory, wherein the accessory comprises at least one of a blanket, a jacket, a pant, a boot, a glove, a storage box, a cooler, a garment forced air dryer rack, or a tent.

8. The recreational vehicle of claim 1, wherein a length of each respective duct of the plurality of ducts is less than approximately 6 feet (1.83 meters).

9. The recreational vehicle of claim 1, wherein the select portions of the cab comprise at least one of a ventilated seat and a helmet ventilation coupling port, and wherein a length of a respective duct of the plurality of ducts fluidly coupled to the at least one of the ventilated seat and the helmet ventilation coupling port is less than about 3 feet (0.91 meters).

10. The recreational vehicle of claim 1, wherein the recreational vehicle further comprises a radiator operatively coupled to at least a portion of the powertrain by at least one coolant line, wherein the coolant line is routed outside of or proximate to a lateral outer extent of the cab, and wherein the at least one coolant line is exposed to the atmosphere.

11. The recreational vehicle of claim 1, wherein the recreational vehicle further comprises:
a rock slider coupled to and extending laterally outward from at least a portion of the frame assembly; and
a radiator operatively coupled to at least a portion of the powertrain by at least one coolant line, wherein the at least a portion of the cooling line is routed through at least a portion of the rock slider.

12. The recreational vehicle of claim 1, wherein the core is oriented in an upright orientation between seatbacks of a first seat and a second seat of the plurality of seats.

13. A heating, ventilation, and air-conditioning (HVAC) system for a recreational vehicle, comprising:
a body extending from a lower portion to an upper portion, the body includes:
a plenum extending between the lower and upper portions;
wherein the lower portion includes an air inlet in communication with the plenum; and
wherein the upper portion includes an air outlet in communication with the plenum;
a heater core within the plenum, the heater core and operatively coupled to a coolant system of a powertrain of the recreational vehicle;
an evaporator within the plenum, evaporator operatively coupled to an air-conditioning circuit of the recreational vehicle;
a blower within the plenum and configured to move air through the heater core and the evaporator;
a blend door coupled with the body and configured to selectively control air flow through the heater core and the evaporator;
a recirculation circuit extending through the body, the recirculation circuit includes:
a recirculation inlet in communication with the air outlet;
a recirculation outlet in communication with the air inlet; and
a recirculation blend door between the recirculation inlet and the recirculation outlet, and the recirculation blend door is configured to control a flowrate of the air through the recirculation circuit.

14. The HVAC system of claim 13, further comprising at least one toolless mechanical coupling configured to couple the body to a portion of a frame of the recreational vehicle.

15. The HVAC system of claim 13, further comprising a plurality of ducts fluidly coupled to the air outlet and configured to direct the moved air to select portions of the recreational vehicle.

16. A method of controlling an air temperature within a cab of a recreational vehicle, the method comprising:
a heating, ventilation, and air conditioning (HVAC) system operably coupled to a powertrain supported by a frame assembly supported by a plurality of ground-engaging members, wherein the method comprises:
determining, by a controller of the HVAC system, based on a cab temperature signal received from a temperature sensor, a current cab temperature;
determining, by the controller, based on a setpoint temperature signal received from a user interface, a selected cab temperature;
determining, by the controller, a differential between the current cab temperature and the selected cab temperature; and
controlling, by the controller, based on the differential, an actuation of a recirculation valve of the HVAC system.

17. The method of claim 16, wherein the HVAC system is supported by and removably coupled to the frame assembly, and wherein the method further comprises removably coupling the HVAC system to the frame assembly.

18. The method of claim 16, wherein the method further comprises positioning the HVAC system along a lateral midline of the recreational vehicle between a dash and a rear close-off of the vehicle.

19. The method of claim 16, wherein the HVAC system further comprises a heater core configured to selectively heat air, an evaporator core configured to selectively cool the air, a blower configured to move the air through the core, and wherein the method further comprises controlling, by the controller, based on the differential, a power state of at least one of the heater core, the evaporator core, and the blower.

20. The method of claim 16, wherein the HVAC system further comprises a plurality of ducts configured to direct the moved air to select portions of a cab of the recreational vehicle, and wherein the method further comprises coupling a respective duct of the plurality of ducts to at least one of a ventilated seat and a helmet ventilation coupling port.

21. The method of claim 16, wherein the HVAC system further comprises a plurality of ducts configured to direct the moved air to select portions of a cab of the recreational vehicle, and wherein the method further comprises coupling a respective duct of the plurality of ducts to at least one auxiliary coupling port configured to fluidly couple to an accessory, and wherein the accessory comprises at least one of a blanket, a jacket, a pant, a boot, a glove, a storage box, a cooler, a garment forced air dryer rack, or a tent.
